(19) United States
(12) Patent Application Publication
(10) Pub. No.: US 2008/0099944 A1
(43) Pub. Date: May 1, 2008

(54) Stamped product in particular for permanently obturating holes

(75) Inventors: Ute Lipprandt, Hamburg (DE); Frank Kolmorgen, Hamburg (DE); Matthias von Samson-Himmelstjerna, Henstedt-Ulzburg (DE); Silke Zweibarth, Hamburg (DE); Audrey Bohmer, Hamburg (DE); Carsten Bohmer, Hamburg (DE); Patrick Gehringer, Bois le Roi (FR)

Correspondence Address: Mark D. Marin;Norris McLaughlin & Marcus, PA, 875 Third Avenue, 18th Floor, New York, NY, 10022, US

(73) Assignee: tesa AG, Hamburg (DE)

(21) Appl. No.: 11/831,436

(22) Filed: Jul. 31, 2007

(30) Foreign Application Priority Data
Aug. 15, 2006 (DE) 102006038322.2

(51) Int. Cl. B29C 65/02; B32B 7/02

(52) U.S. Cl. 264/41; 428/212

(57) ABSTRACT

Stamped product intended particularly for permanently obturating holes, especially in metal sheets or in plastic parts, having an at least partly single-sidedly self-adhesively treated base layer comprising a heat-resistant backing, the base layer being shaped so as to extend at least sectionally beyond the outer margin of the hole that is to be obturated, and the base layer being provided on the adhesively treated side with a block of a heat-activable foamable material whose area is greater than the area of the hole to be obturated and preferably less than the area of the base layer, the stamped product being applied over the hole to be obturated, in such a way that the hole is completely covered by the stamped product.

The present invention relates to a stamped product intended in particular for permanently obturating holes located, preferably, in metal sheets or in plastic parts, and also to a method of permanently obturating holes.

In the course of the manufacture of relatively complex structures from metal sheets and/or plastics it is inevitable that holes will have to be cut into the sheets or plastics as a consequence of the construction system, in order to gain access to cavities situated behind them, whether for the purpose of painting or for the purpose of welding.

After the end of the desired operation, these holes are usually no longer needed, and in fact are often disruptive, since air, atmospheric moisture or water can penetrate through them into the structure, and this can lead, for example, to oxidation processes (rust).

A simple solution for the avoidance of these problems is to obturate the holes again after use.

Specifically in the course of the production of modern vehicles such as watercraft, land vehicles (lorries, cars, etc.), aircraft, spacecraft, and combinations thereof, such as amphibious vehicles, for example, it is inevitable that, in the course of assembly, holes of various sizes will come about in numerous individual parts made of metal sheets or plastics. The diameters of the holes are typically between 5 and 50 mm. In subsequent operation, many of these holes must be obturated again in such a way that they are airtight and, in particular, watertight, in order to prevent corrosive attack by water or water vapour penetrating through the non-covered holes into the vehicle body.

An accompanying requirement is that of obturating the holes to achieve a considerable improvement in the suppression of noise in the passenger compartment.

In the text below, the problems on which the invention is based, and their solution, are described using the example of the body of a car. This explicitly does not constitute a restriction of the inventive concept to this application. This application is part of the technical field in which the invention comes to bear with particular advantage.

When, from this point on, reference is made to use in a vehicle body, the person skilled in the art will understand this to embrace all other application possibilities outside of a vehicle body.

At the present time, bodywork holes are generally obturated using plastic stoppers, which on the one hand do not reliably obturate the hole in certain cases and on the other hand are comparatively complicated and expensive to produce.

Each size of hole requires a specific stopper adapted to the hole size. This involves high logistical and administration complexity and cost for the purchaser of the stoppers.

On the production line, consequently, a large number of stoppers in different sizes must be held, each in allocated storage bins.

Additionally suitable for this purpose are adhesive tapes which are stamped or separated into lengths to fit the size of hole. Even adhesive tapes, however, do not always come up to the increasing requirements in the market.

As already described in WO 2006/053827 A1, the systems suitable for specific hole obturation include stamped products which are composed of an at least partially single-sidedly self-adhesively treated base layer comprising a heat-resistant backing whose area is greater than the area of the hole that is to be obturated, the base layer being provided, in particular centrally, on the adhesively treated side, with a first section of a heat-activable adhesive sheet whose area is greater than the area of the hole to be obturated and less than the area of the base layer. The stamped product is applied over the hole that is to be obturated, in such a way that the hole is essentially covered by the first section. The heat-activable adhesive sheets described are highly suitable for sealing, but are comparatively expensive.

The possibility of introducing into the stamped product a component which, at an elevated temperature such as in a drying step in the coating area, fills the hole fully and/or covers it fully, by foaming, is described in WO 2005/097582 A1. However, it emerges that the unfoamed component is required to exhibit a high level of expansion in order to ensure complete obturation of the hole, since the direction of spread is limited only by the adhesion side to the single-sidedly self-adhesive stamped product. As a result of this necessarily high degree of foaming, the density of material in the resulting obturated hole is comparatively low, which has adverse consequences for the noise-damping properties. Additionally, the strength of a hole obturation of this kind is low in terms of foam adhesion to the metal sheet, since the material comes into contact only with the hole margin and with little metal sheet on the side facing away from the stamping. The result is a low penetration strength, a quality which is of critical importance for the field of application described.

A distinct improvement can be obtained by laminating onto the stamped product a foamable material which, moreover, has thermoadhesive properties, as described for example in EP 1 114 113 A1 for EVA based adhesion components. Thus the protruding margin of adhesive tape is able to ensure the fastening of the thermoadhesive stamping in any desired shape and size, and after a temperature treatment the foamed material additionally adheres itself, as a result of a firm bond which it has developed to the substrate, and it fills the hole and seals the assembly as well. In addition, the foamable material can be reinforced with a temperature-stable nonwoven, made for example of polyester fibre.

Stampings suitable for hole obturation of this kind include those comprising adhesive tape and thermoadhesive materials based on heat-activable rubber materials and synthetic-rubber materials, as described for example in DE 100 62 859 A1 and in WO 2005/118735 A1.

It is an object of the invention to provide a stamped product suitable for permanently obturating holes, especially in metal sheets or in plastic parts of car bodies, that obturates the said holes in such a way that the passage of moisture is excluded, the noise suppression is improved, and the holes are reliably obturated even in the event of stonechipping on the underbody and/or in the event of mechanical stresses in the interior, particularly in the floor area.

This object is achieved by means of a stamped product as set down in the main claim. The subclaims provide advantageous developments of the subject matter of the invention, and also a method of permanently obturating holes.

The invention accordingly provides a stamped product intended particularly for permanently obturating holes, especially in metal sheets or in plastic parts, having an at least partly single-sidedly self-adhesively treated base layer comprising a heat-resistant backing, the base layer being shaped so as to extend at least sectionally beyond the outer margin of the hole that is to be obturated, and the base layer being provided on the adhesively treated side with a block of a heat-activable foamable material.

The area of the block is greater than the area of the hole to be obturated and preferably less than the area of the base layer, the stamped product being applied over the hole to be obturated, in such a way that the hole is completely covered by the stamped product.

The base layer need not cover the block of the heat-activable foamable material all round. According to one advantageous embodiment, however, this is the case. With a rectangular base area of the base layer, for example, the base layer may protrude beyond the block only in two sections. Even a strip of the base layer which is narrower than the block of the heat-activable foamable material may take on the function of the secure positioning of the stamped product.

With further preference the area of the base layer is greater than the area of the unfoamed block.

In one advantageous embodiment of the invention there is, between the base layer and the block of the heat-activable foamable material, a laminar body, which with particular advantage is composed of metal, of a metal foil, for example of an aluminium foil, of a metal-containing foil or else of rigid plastic sheets, such as PET sheets, for example. The body is preferably self-adhesively treated on one or both sides, advantageously with the adhesives elucidated below.

The sheets preferably have a thickness of between 30 and 500 μm, the metal foils up to 3 mm.

The laminar body has strength in order to increase the stability of the stamped product as a whole. In particular the penetration strength, which is determined by obturating a hole with a stamped product and subjecting it to controlled penetration.

The methodology is based on the use of a tensile testing machine into which a pin is clamped in the upper force transducer, the pin moving at constant speed (300 mm/min) onto a horizontally positioned hole in a metal sheet which is in turn obturated with the stamping. The hole chosen is a circular cut-out 40 mm in diameter. The steel sheet has a thickness of 1 mm and is sited on a ring, so that the pin is able to pass through the hole for up to 30 mm on being pressed into the hole's obturation. The tip of the pin is rounded and represents the head of an ISO 8677 cup head bolt having a diameter of 20 mm and an arc height of 3 mm, welded to one transducer. The force needed to press the pin 30 mm through the hole is measured. In the case of very good metal-sheet adhesion, this figure correlates with the tensile elongation properties of the laminar body in the lengthwise and transverse directions.

Laminar bodies which can be used to reinforce the stamped product have penetration strengths, according to one advantageous embodiment of the invention, of 200 to 2000N.

It is preferred for the stamped product to have a symmetrical structure, and in particular for the base layer, the block and the body present if desired to be arranged concentrically, and especially for this stamped product to have been applied concentrically over the hole that is to be obturated.

The contours of the base layer, of the block and of the body present if desired correspond advantageously to the contour of the hole that is to be obturated. This applies in particular in respect of the block.

This produces a symmetrical projection of the individual layers of the stamped product.

The backing, which in one advantageous development of the invention is composed of an aluminium foil, a textile backing or a plastic sheet (for example PVC, PP, PET, PU), preferably has a thickness of
between 30 and 120 μm for the aluminium foil,
between 100 and 300 μm for a textile backing, and
between 30 and 300 μm for a plastic sheet.

Backing material used for the stamped product in one particularly advantageous continuation of the invention comprises woven cotton fabric having in particular a mesh count of 140 to 160, preferably 148 (implying a warp thread count of 74 and a weft thread count of 74).

With further preference the weft count is 70 to 80 and/or the warp count is 70 to 80.

As backing material for the stamped product it is possible in addition to use all known textile backings such as wovens, knits or nonwoven webs; the term “nonwoven web” embraces at least textile sheetlike structures in accordance with EN 29092 (1988) and also stitchbonded nonwovens and similar systems. It is likewise possible to use spacer fabrics, including wovens and knits, with lamination.

Starting materials envisaged for the textile backing include, in particular, polyester, polypropylene, viscose, staple rayon or cotton fibres. The present invention is, however, not restricted to the stated materials; rather it is possible to use a large number of other fibres to produce the web, as is evident to the skilled worker without any need for inventive activity. What is important is that the materials used have the requisite heat resistance.

As adhesives on the backing it is possible in principle to choose a variety of polymer systems, with natural-rubber or synthetic-rubber systems and also acrylate systems having proved to be particularly advantageous if their adhesive properties and temperature stabilities are in accordance with the requirements. With further preference the bond strength to steel is at least 5 N/25 mm.

A suitable adhesive is one based on acrylate hotmelt which has a K value of at least 20, more particularly greater than 30 (measured in each case in 1% strength by weight solution in toluene, 25° C.), obtainable by concentrating a solution of such an adhesive to give a system which can be processed as a hotmelt.

Then it is possible to use an adhesive composed from the group of the natural rubbers or the synthetic rubbers, or composed of any desired blend of natural rubbers and/or synthetic rubbers, the natural rubber or rubbers being selectable in principle from all available grades such as, for example, crepe, RSS, ADS, TSR or CV grades, depending on the required purity and viscosity levels, and to select the synthetic rubber or rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible to add thermoplastic elastomers to the rubbers, in order to improve the processing properties, with a weight fraction of 10% to 50% by weight, based on the total elastomer fraction.

As representatives, mention may be made at this point in particular of the especially compatible styrene-isoprene-styrene (SIS) and styrene-butadiene-styrene (SBS) products.

Tackifying resins which can be used include, without exception, all tackifier resins which are already known and have been described in the literature. As representatives, mention may be made of the rosins, their disproportionated, hydrogenated, polymerized and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Express reference may be made to the depiction of the state of the art in the “Handbook of Pressure Sensitive Adhesive Technology” by Donatas Satas (van Nostrand, 1989).

With further preference the heat-activable foamable material of the unfoamed block is composed of vulcanizable rubber material or, with particular preference, of an EVA material, and has a thickness of 0.5 to 3 mm.

The latter is composed of an attachment component and an armouring component. The attachment component is composed of EVA-maleic anhydride copolymer, modified where appropriate with PE, PP and modified EVA, which carries epoxide functions for the crosslinking process. The armouring component preferably comprises polyether-block-esters and polyether-block-amines, optionally in the form of a mixture with ethylenepropylene copolymer, the latter also being replaceable by EPDM.

The vinyl acetate content of the EVA is with advantage approximately 5% to 40% by weight. The grafted-on maleic anhydride is present at approximately 0.4% to 12% by weight. The remainder is composed of further polyolefin components, including terpolymers, fillers such as chalk, barium sulphate, colorants, heat-activable blowing agents, and further additions such as resins, flame retardants, reinforcements, fungicides, antioxidants, light stabilizers and heat stabilizers. The EVA is preferably extruded to form a matrix.

The vulcanizable rubber material is composed advantageously of a reactive composition based on natural and/or synthetic rubbers, i.e. double-bond-containing copolymers and/or block copolymers and terpolymers based on butylene, isobutylene, ethylene, propylene, acrylonitrile, butadiene, isoprene, cyclopentadiene, styrene and combinations thereof with halogenated monomers. Use may be made of liquid rubbers, solid rubbers, and elastomers, which are admixed with adjuvants such as fillers, blowing agents, vulcanizing agents, vulcanization accelerants, catalysts, ageing inhibitors and rheological assistants. Liquid rubbers are in particular telechelic polymer chains with terminal functionalization. Adhesion promoters as well, organosilanes in particular, may be incorporated in the formula.

A typical size for the unfoamed block, which can be used to obturate many of the smaller holes, represents a disc having a diameter of 10 to 60 mm, more particularly 30 to 40 mm.

As a result of the chemical crosslinking reaction (based on epoxides and maleic anhydride blocks and/or vulcanizing agents and organosilanes) within the heat-activable foamable material at elevated temperature, high strengths are achieved between the material and the surface where bonding is to take place, and the product attains a high internal strength.

The heat-activable foamable materials are distinguished by a series of advantages:
They possess high cohesion and elasticity at room temperature.
They exhibit high adhesion to the typical substrates in automotive engineering.

Particularly advantageous for the concept of the invention is a fogging-free stamped product, comprising a fogging-free backing to at least one side of which is applied a fogging-free, pressure-sensitive adhesive, and also comprising a fogging-free block of the heat-activable foamable material.

The stamped product is joined durably to the bodywork by briefly exposing the stamped product to high temperatures, leading to the activation of the heat-activable foamable material. Temperatures above 120° C. and below 200° C. have proved to be particularly advantageous, and the exposure to such temperature should be approximately 20 minutes.

The method of obturating a hole, in particular in a vehicle body, with a stamped product of the invention is characterized by the following steps:
applying the stamped product to the hole to be obturated, in such a way that the hole is covered completely by the stamped product, in particular by the block
exposing the stamped product to temperatures of 120° C. to 200° C. for approximately 20 minutes, so that the first section of the heat-activable foamable material foams and thereby fills the hole, and in particular completely surrounds the hole edge.

The foaming of the stamped product takes place preferably through supply of heat during the typical finishing operation on the body shell, in particular during the drying after coating, drying after underbody protection or drying after cathodic electrodeposition. In this way no additional operation is needed.

Owing to the required heating of the body during the said drying operations, there is sufficient energy present to cause foaming expansion of the foam bodies.

An alternative option is to carry out foaming expansion by local supply of energy, by means of radiant heaters or infrared lamps.

Particularly in the case of heightened mechanical stress, the stamped product of the invention is superior to the solutions known from the prior art. The same applies in consideration of noise suppression. Noise suppression and strength are massively improved through the combination of base layer/heat-activable foamable material/laminar body.

In addition it is possible for a single embodiment of the stamped product to cover a multiplicity of different-sized holes.

The stamped product is distinguished by:
very high load-bearing capacity/penetration resistance
very good sealing with respect to moisture/moisture barrier
effective sealing with respect to noise/sound deadening
simple and inexpensive facility, by laminated incorporation of heavyweight materials, metal platelets for example, for achieving an additional high strength of the assembly and an attenuation of noise.

Moreover, the foamed stamped product surrounds the sensitive hole edge, whose thin paint film constitutes a weak point in corrosion control, with foamed material, thereby providing it with particular protection.

Below, with reference to two figures, the stamped product for permanently obturating holes, more particularly in metal sheets or in plastic parts of car bodies, will be illustrated in greater detail, without any intention that this should in any way have a restrictive effect.

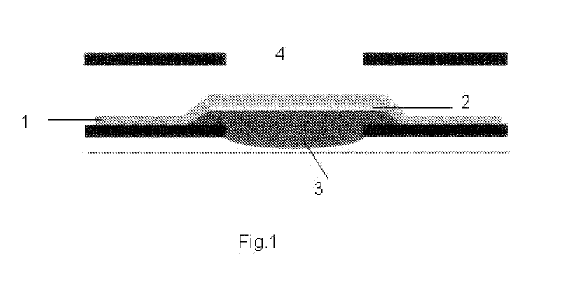

FIG. 1 shows a hole in a body that requires obturation, and also the state after the hole to be obturated has been obturated as a result of heat exposure, and

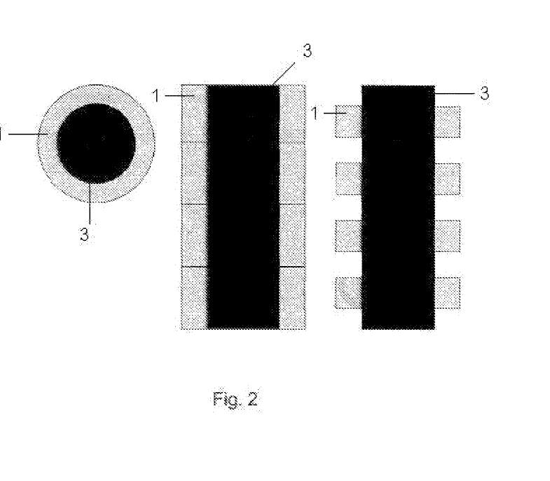

FIG. 2 shows various embodiments of the stamped product.

In the body 5, as a result of the construction system, there is a hole 4 requiring obturation.

For this purpose a stamped product with a base layer 1, which has a woven textile backing or a plastic sheet backing, treated with an adhesive layer, is fixed to the hole 4 in such a way that the hole 4 is completely covered by the stamped product.

The area of the stamped product is greater than the area of the hole 4 to be obturated.

Located centrally on the base layer 1, and on the adhesively treated side, is a laminar body 2, made of metal, of a metal foil or of a rigid plastic sheet, in this case of a metal foil.

Present on the body 2 is a block 3 and a heat-activable foamable material whose area is greater than the area of the hole 4 to be obturated and smaller than the area of the base layer 1, but greater than or the same size as the laminar body 2.

The stamped product is joined durably to the body 5 by brief exposure of the stamped product to high temperatures, which lead to the activation of the block of the heat-activable foamable material 3.

With regard to the construction of the product, moreover, there are further conceivable geometries, as shown in FIG. 2, so that the base material 1 need not cover the heat-activable foamable material all round, but instead, in the case of rectangular specimens, protrudes only in two dimensions in the width of the heat-activable foamable material. Even a strip of base material which is narrower than the heat-activable foamable material can take on the positioning function.

1. Stamped product for permanently obturating holes comprising an at least partly single-sidedly self-adhesively treated base layer comprising a heat-resistant backing, the base layer being shaped so as to extend at least sectionally beyond the outer margin of the hole that is to be obturated, and the base layer being provided on the adhesively treated side with a block of a heat-activable foamable material whose area is greater than the area of the hole to be obturated and preferably less than the area of the base layer, the stamped product being applied over the hole to be obturated, in such a way that the hole is completely covered by the stamped product.

2. Stamped product according to claim 1, wherein a laminar body is located between the base layer and the block of the heat-activable foamable material.

3. Stamped product according to claim 2, wherein the laminar body is selected from the group consisting of metal, metal foil, metal-containing foil and rigid plastic sheets.

4. Stamped product according claim 1 wherein the base layer protrudes beyond the outer margin of the hole at every point.

5. Stamped product according to claim 4 wherein the area of the base layer is greater than the area of the block.

6. Stamped product according to claim 2 wherein the stamped product has a symmetrical structure and/or the base layer, the block and the laminar body are arranged concentrically when the stamped product is applied concentrically over the hole that is to be obturated.

7. Stamped product according to claim 2 wherein the contours of the base layer, of the block and of the laminar body correspond to the contour of the hole that is to be obturated.

8. Stamped product according to claim 1 wherein the backing material comprises an aluminium foil, a textile backing or a plastic sheet.

9. Stamped product according to claim 1 wherein the heat-activable foamable material of the unfoamed block is composed of vulcanizable rubber material.

10. Method of obturating a hole, in particular in a vehicle body, with a stamped product according to claim 1 comprising:
applying the stamped product to the hole to be obturated, in such a way that the hole is covered completely by the stamped product, in particular by the block,
exposing the stamped product to temperatures of 120° C. to 200° C. for approximately 20 minutes, so that the block of the heat-activable foamable material foams and thereby fills the hole, and completely surrounds the hole edge.

11. (canceled)

12. Stamped product according to claim 3 wherein the plastic sheets comprise PET.

13. Stamped product according to claim 3 wherein the laminar body is treated with an adhesive on at least one side.

14. Stamped product according to claim 8 wherein the plastic sheet is comprised of PVC, PP, PET or PU.

15. Stamped product according to claim 8 wherein the textile backing comprises a woven cotton fabric.

16. Stamped product according to claim 15 wherein the woven cotton fabric has a weft count of 70 to 80.

17. Stamped product according to claim 15 wherein the woven cotton fabric has a warp count of 70 to 80.

18. Stamped product according to claim 1 wherein the block of heat-activable foamable material is EVA.

19. Stamped product according to claim 1 wherein the block of heat-activable foamable material has a thickness of 0.5 to 3 mm.
